(19) United States
(12) Patent Application Publication
(10) Pub. No.: US 2003/0097305 A1
(43) Pub. Date: May 22, 2003

(54) Custom synthesis pharmaceutical electronic commerce system and method

(76) Inventors: Yasukazu Ogino, Tokyo (JP); Takayo Kinoshita, Tokyo (JP); Haruhiko Kusaka, Mountain View, CA (US); Ramesh Raman, San Carlos, CA (US)

Correspondence Address: FLEHR HOHBACH TEST, ALBRITTON & HERBERT LLP, Suite 3400, Four Embarcadero Center, San Francisco, CA, 94111, US

(21) Appl. No.: 09/991,135

(22) Filed: Nov. 16, 2001

(51) Int. Cl. G06F 17/60

(52) U.S. Cl. 705/26

(57) ABSTRACT

An electronic commerce system for enabling business transactions between one or more customers is provided. The system generally includes a customer system which provides information representative of the needs of one or more customer for the procurement of custom synthesis products and/or services; a supplier system which provides information representative of the capabilities, of one or more suppliers to supply custom synthesis products and/or services; and a business supporting system which facilitates business transactions between one or more customers and suppliers.

### FIELD OF THE INVENTION

The present invention relates in general to electronic commerce systems and methods. More specifically, the present invention relates to a system and method for providing electronic commerce for custom synthesis products and services for pharmaceutical and chemical companies.

### BACKGROUND OF THE INVENTION

With the advent of the information age, businesses are increasingly seeking ways to increase productivity and streamline access to information and technology. The automation of many fundamental business functions, such as procurement of products, has evolved at an amazing rate. Just a few years ago performing such functions required much more labor, effort and cost.

As a consequence of information technology developments, and the increasing usage of the Internet, many types of electronic commerce systems have been developed. Most electronic commerce systems focus on marketing and selling of consumer goods, and include on-line systems for ordering and processing credit card payments for the goods. While such consumer based electronic systems have become popular, they are not suited to the needs of businesses.

The Internet has rapidly become recognized as a potential tool for businesses. Most industries have significant need for the procurement of many types of goods, particularly for non-custom or commodity type goods. For example, chemical and pharmaceutical companies are users of large quantities of commodity chemicals. To serve this business need, a number of web sites have been developed. Examples of two web sites focusing on the pharmaceutical industry are www.pharmaceuticalonline.com and www.pharma-outsourcing.com. Such web sites generally display on-line catalogs showing commodity products offered by various vendors, marketplace news and information, as well as links to other relevant resources. The web sites also typically offer purchasing capability on-line.

While these web sites are useful for pharmaceutical or chemical businesses, their offerings are limited and do not truly facilitate in an electronic manner many of the needs of conducting business. For example, many pharmaceutical companies require chemicals that are not currently available, but instead must be custom synthesized.

Recently, there is a significant trend in the pharmaceutical industry to shift their business focus from producing drugs to a focus of developing new drugs. To implement this business strategy, pharmaceutical companies are increasingly turning to custom synthesis companies to produce chemicals, including drugs and their intermediates, and the like. This growth in demand for custom synthesis business has resulted in an increase in the number of customer synthesis companies doing business. The search for a suitable company to provide custom synthesis services and/or products is often a complex, time consuming endeavor which requires significant research by the pharmaceutical company. Moreover, the selection of a suitable supplier company is often a strategic matter. Thus, companies often spend significant resources in a search for a suitable supplier or partner. For example, once a company identifies a need for a supplier or partner in a particular field, the company conducts research to first identify what companies are in the field. Next, the company researches, within the group of potential companies, what the capabilities of each are.

When searching for a custom synthesis supplier the desired capabilities may often be vast due to the complex technical and regulatory nature of the business. Moreover, often times the required information is not conveniently available. For example, when inquiring about a suppliers FDA audit report, this information may need to be obtained from other sources. In addition, once all of the relevant information is gathered, there is no guarantee that a relationship will be entered into. In fact, the majority of efforts do not result in the commencement of a business relationship, and so much of the effort is essentially wasted. Accordingly, providing a centralized electronic site with capability for these more complex, strategic business functions would be of great benefit to the pharmaceutical and chemical industries.

### SUMMARY OF THE INVENTION

Accordingly, it is an object of the present invention to provide an electronic commerce system and method. More specifically, it is an object of the present invention to provide an electronic commerce system and method enabling the exchange of custom synthesis products and/or services in the pharmaceutical and chemical industries.

These and other objects and advantages are provided by the present invention wherein as broadly described an electronic commerce system for enabling business transactions between one or more customers and suppliers is provided, comprising a customer system which provides information representative of the needs of one or more customers for the procurement of custom synthesis products and/or services; a supplier system which provides information representative of the capabilities of one or more suppliers to supply the custom synthesis products and/or services; and a business supporting system which facilitates business transactions between the one or more customers and suppliers.

In one embodiment the electronic system includes a customer registration database having one or more records which contain information representative of one or more customers needs, and a supplier registration database having one or more records which contain information representative of one or more suppliers capabilities.

In another embodiment of the present invention records in each of customer and supplier registration databases include a plurality of fields, and each field has associated with it a selectable access or security level which determines a level of access and display of the information in the field. In a further embodiment, the business supporting system further comprises an email server which implements electronic communication between customers and supplies, and the email server includes software and/or hardware configured to permit secure communications between the customers and suppliers.

In yet another embodiment of the present invention, the business supporting system further comprises a news database which stores and displays information relevant to interests of the customers and supplies.

In a further embodiment, the business supporting system includes one or more database management systems having software and/or hardware configured to search the customer and supplier registration databases responsive to a request from the customer or supplier for desired information. Of particular advantage, the customers and/or suppliers may specify what information is searchable.

The system and method of the present invention may also include software and/or hardware configured to implement an auction wherein one or more of the suppliers or customers offer bids to supply or procure custom synthesis products and/or services. The auction may be conducted as either an open auction where any of the customers and/or suppliers participate in the auction, or a private auction where only authorized customers and supplier participate in the auction.

In another embodiment, the present invention may provide for payment of a variety of fees. For example, the system may include one or more advertisements displayed thereon upon payment of an advertising fee to an administrator of said business supporting system. The system may include a registration fee payable by any of said one or more customers and suppliers upon registration with the business supporting system. A site unitization fee may be payable by any of the customers and/or suppliers for use of the business supporting system. Additionally, a business fee may be payable by the customers and/or suppliers for commencement of a business transaction between the customer and supplier. The business fee may be a fixed fee or a percentage of a value of the business transaction. And lastly, an auction fee may be payable the customers and suppliers for conducting an audit on said business supporting system.

In another aspect of the present invention, a computer readable medium is provided containing instructions which, when executed by a computer, provide an electronic commerce system which enables business transactions between one or more customers and suppliers, by: receiving information representative of needs of one or more customers for the procurement of custom synthesis products and/or services; receiving information representative of capabilities of one or more suppliers to supply the custom synthesis products and/or services; and facilitating business transactions between the one or more customers and suppliers.

In yet another aspect of the present invention, a method of enabling business transactions between one or more customers and suppliers is provided, comprising the steps of receiving information representative of needs of one or more customers for the procurement of custom synthesis products and/or services; receiving information representative of capabilities of one or more suppliers to supply the custom synthesis products and/or services; and facilitating business transactions between the one or more customers and suppliers. In another embodiment, the inventive method includes establishing a customer registration database having one or more records which contain information representative of a customers needs, and a supplier registration database having one or more records which contain information representative of a suppliers capabilities.

In another embodiment, the method of the present invention includes selecting an access or security level to be associated with fields established in each of the records in each of the customer and supplier registration databases which determines a level of access and display of the information in the field.

In a further embodiment, the method of the present invention includes searching any one of the customer and supplier registration databases responsive to a request from the customer or supplier for information. In yet another embodiment, the method of the present invention includes conducting an auction where one or more of the suppliers or customers offer bids to supply or procure custom synthesis products and/or services.

### BRIEF DESCRIPTION OF THE DRAWINGS

Other objects and advantages of the present invention will become apparent upon reading the detailed description of the invention and the appended claims provided below, and upon reference to the drawings, in which:

FIG. 1 is a simplified block diagram illustrating the major participants in the system and method of the present invention.

FIG. 2 is a high-level block diagram illustrating the computer architectural of the business supporting site according to one embodiment of the system and method of the present invention.

FIG. 3 is a high-level architectural block diagram showing the various functions of the present invention.

FIG. 4 is a high-level block diagram illustrating the architectural of the registration feature according to one embodiment of the present invention.

FIG. 5 illustrates one example of data fields with different security access levels assigned to each entry in accordance with one embodiment of the present invention.

FIGS. 6a and 6b are a high-level block diagram, and illustration of the flow of information, respectively, showing the computer architecture of the searching function according to one embodiment of the present invention.

FIG. 7 is a high-level block diagram illustrating the computer architecture of the auction function according to one embodiment of the present invention.

FIG. 8 is a flow chart illustrating the utilization fee method according to one embodiment of the present invention.

FIG. 9A is a flow chart illustrating the business fee method according to one embodiment of the present invention.

FIG. 9B is a flow chart illustrating the business fee method according to an alternative embodiment of the present invention.

FIG. 10 is a high level block diagram illustrating one embodiment of the advertisement function of the present invention.

### DETAILED DESCRIPTION OF THE INVENTION

In general the present invention provides a system and method for providing electronic commerce for custom synthesis products and/or services to pharmaceutical and chemical companies. While the description and embodiments described herein focus primarily on pharmaceutical companies, it is to be understood that the present invention is applicable to chemical and other companies who transact business in the area of custom synthesis products and/or services, which are included in its scope. For convenience and to facilitate a complete understanding of the present invention, the detailed description is arranged into sections.

I. Overview of System Components

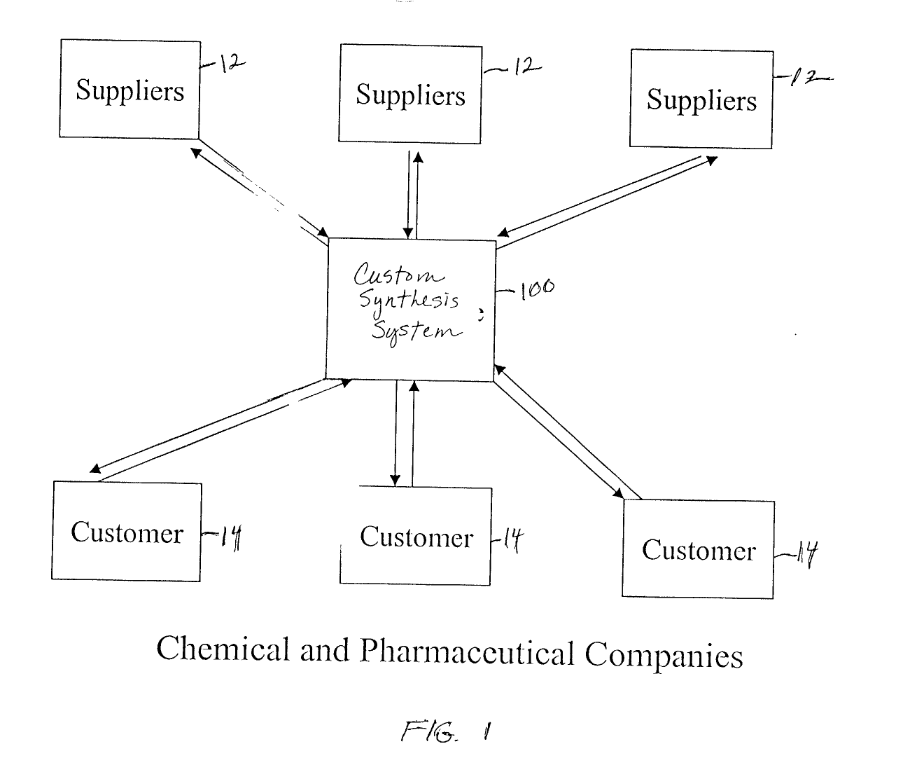

Referring to the drawings, FIG. 1 is a block diagram illustrating the relationships between the entities involved in an electronic commerce system 100 and method of the present invention. In general, an electronic commerce or business supporting site 102 brings together customers and suppliers. On one side, custom synthesis companies, designated broadly as “suppliers” are provided. The suppliers 12 are typically chemical and/or pharmaceutical companies that provide custom synthesis products and/or services. The suppliers may be the actual manufacturers of the custom synthesis products and/or services, however this is not a requirement and the supplier may be a distributor or trading company with access to such custom synthesis products and/or services.

On the other side, pharmaceutical and/or chemical companies, broadly designated as “customers” are provided. The customers 14 are typically chemical and/or pharmaceutical companies that desire to obtain custom synthesis products and/or services. In one example, a customer is a pharmaceutical company that desires to obtain an ingredient, or an intermediate, for its manufacture of a pharmaceutical drug. Alternatively, a distributor and/or trading company may be a customer.

The term “custom synthesis products and/or services” is used herein broadly to include any: chemical compounds, or combination of chemical compounds, that are custom synthesized, and any services associated therewith, or only custom synthesis services. Examples of custom synthesis products include, but are not limited to: pharmaceutical drugs and ingredient, their intermediates, and the like. Examples of custom synthesis services include, but are not limited to: researching reaction routes, process synthesis, optimization of reaction conditions, and the like. Additional illustrative examples are described in the Experimental section below.

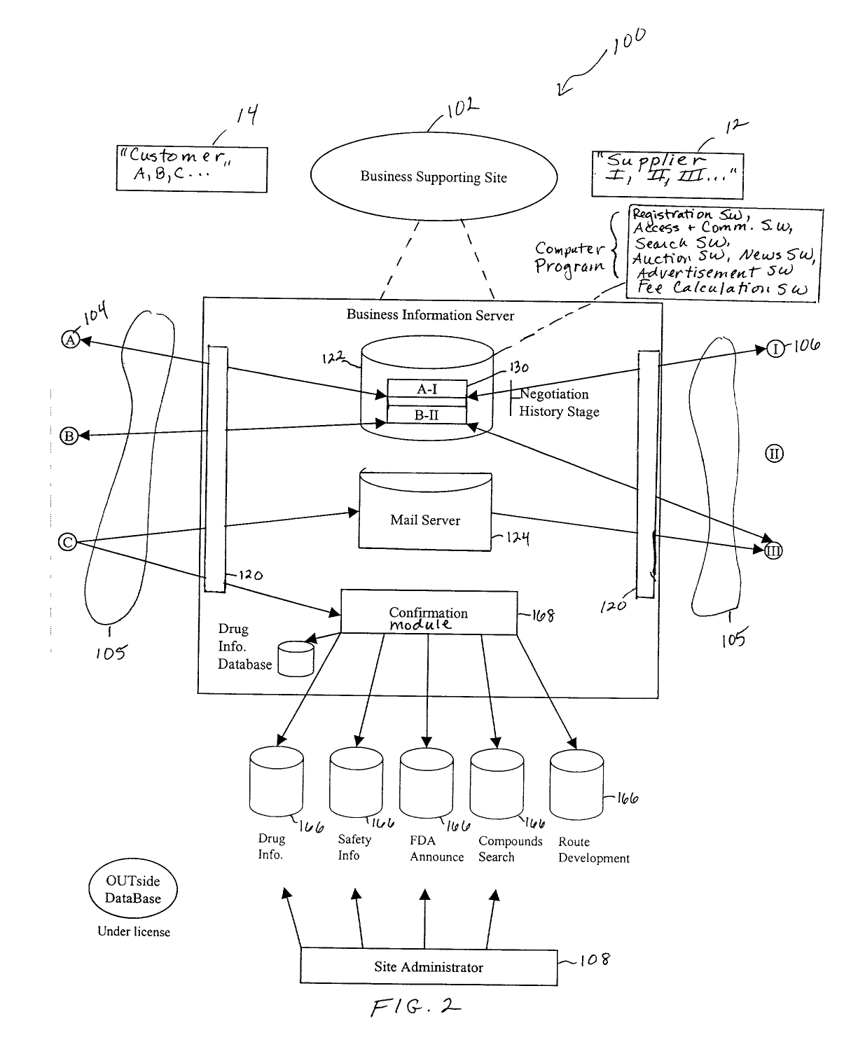

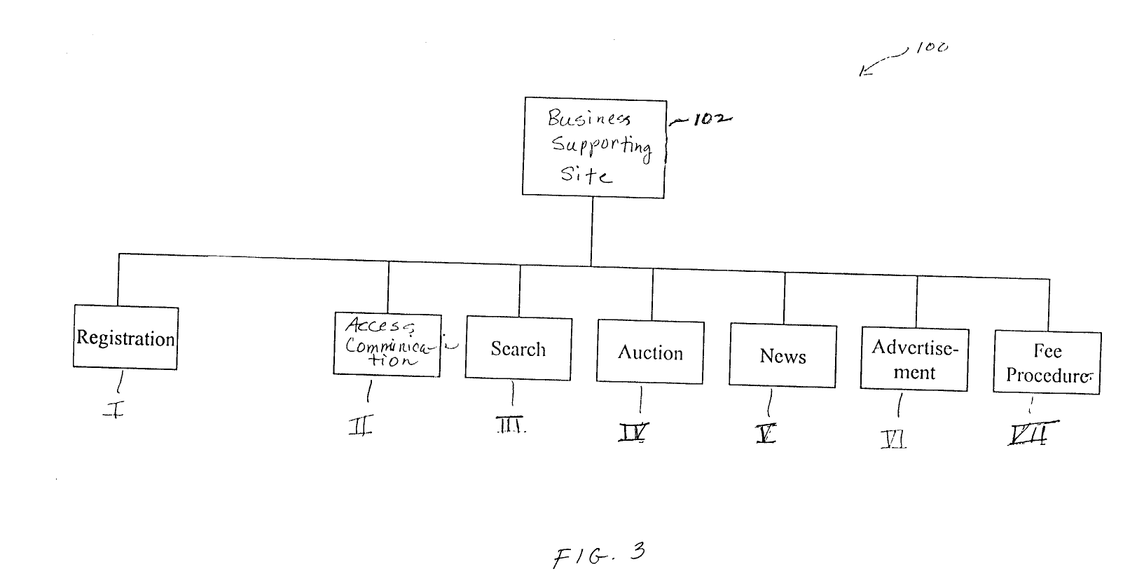

A high level block diagram depicting the various functions and system of the present invention are shown in FIGS. 2 and 3. The present invention provides many features that facilitate the exchange of customer synthesis products and/or services. Prior to the present invention, customers and suppliers were required to commit significant man hours and cost researching many companies in an attempt to find a suitable supplier or customer. Further, once a potential business partner is selected, the companies often spend many hours in meetings negotiating the potential transaction, which is many cases does not result in a firm transaction.

The present invention significancy streamlines this otherwise labor some process by providing a centralized site configured to promote such business transactions between customers and suppliers. In particular, the invention provides one site where relevant detailed information about multiple suppliers and customers is obtained. Instead of a customer conducting research to determine who are the suppliers of a particular product and/or service, and after that initial threshold has been reached, then spending hours researching each company's web site and other publications and marketing materials to obtain information relevant to their specific needs, the present invention simplifies this process significantly.

The general computer architecture of one embodiment of the electronic commerce system 100 is shown in greater detail in FIG. 2. The system 100 includes a business supporting system or site 102, a customer system 104 and a supplier system 106. The customer and supplier systems are generally comprised of computers 104 and 106, and each independently connect to the business supporting site 102 via the Internet 105. The business site 102 is operated by a site administrator 108. Any number of customers and suppliers may connect to the business supporting site 102. For simplification, three customers and suppliers are shown. Throughout the description and Figures, the customers are generally designated by letters, i.e. Customer A, Customer B and so on; while the suppliers are designed by numbers, i.e. Supplier I, Supplier II and so on. The customer and supplier computers 104 and 106 may be any type of computing device that allows interactive browsing of web sites via a web browser, such as Internet Explorer or Netscape which uses the hypertext transfer protocol (HTTP) to communicate with a web server of the business supporting site. For example the customer and supplier computers 104 and 106 may be, but are not limited to, a personal computer (PC) that runs Windows NT™ operating system.

The business supporting site 102 (also referred to herein as the “business site”) provides the functionality for allowing customers 14 to obtain custom synthesis products and/or services. The business site 102 carries out many functions as will be described in detail below. In general, in one embodiment the business site 102 includes three main systems: a web server 120, business information server 122, and mail server 124, all of which are interconnected through a private network (not shown), such as a LAN or ethernet, and software programs and databases described further below for providing the functionality and operation of the system 100. Each of the servers may include CPU(s), software, memory and network interface (all not shown) for communicating over the Internet or a private network, as appropriate. Other embodiments will be described below wherein the business site 102 includes additional systems.

Referring to FIG. 3 and as described in detail below, the present invention is configured to carry out any one, all, or any combination of the following functions: registration, access and communication, searching, auction, news advertisement and fee procedures. In the preferred embodiment, all of the function are implemented by the system 100; however other embodiments are intended to be within the scope of the present invention, and the system 100 may be configured to implement a subset of all the functions, in a variety of combinations.

II. Registration

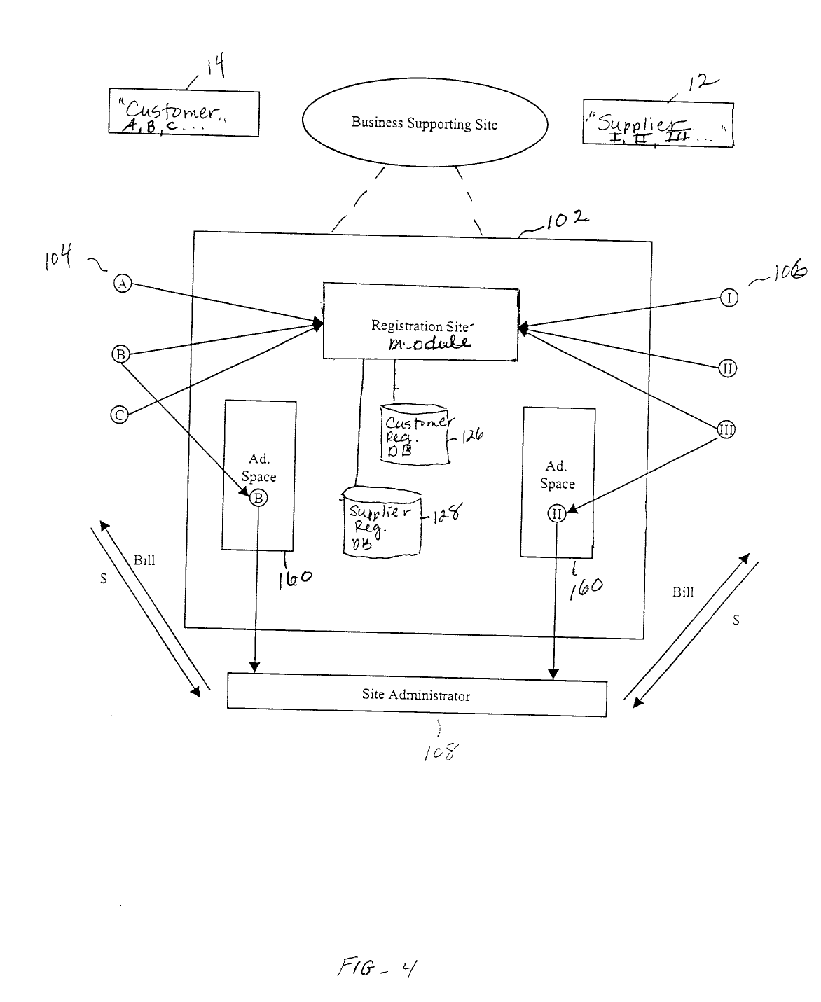

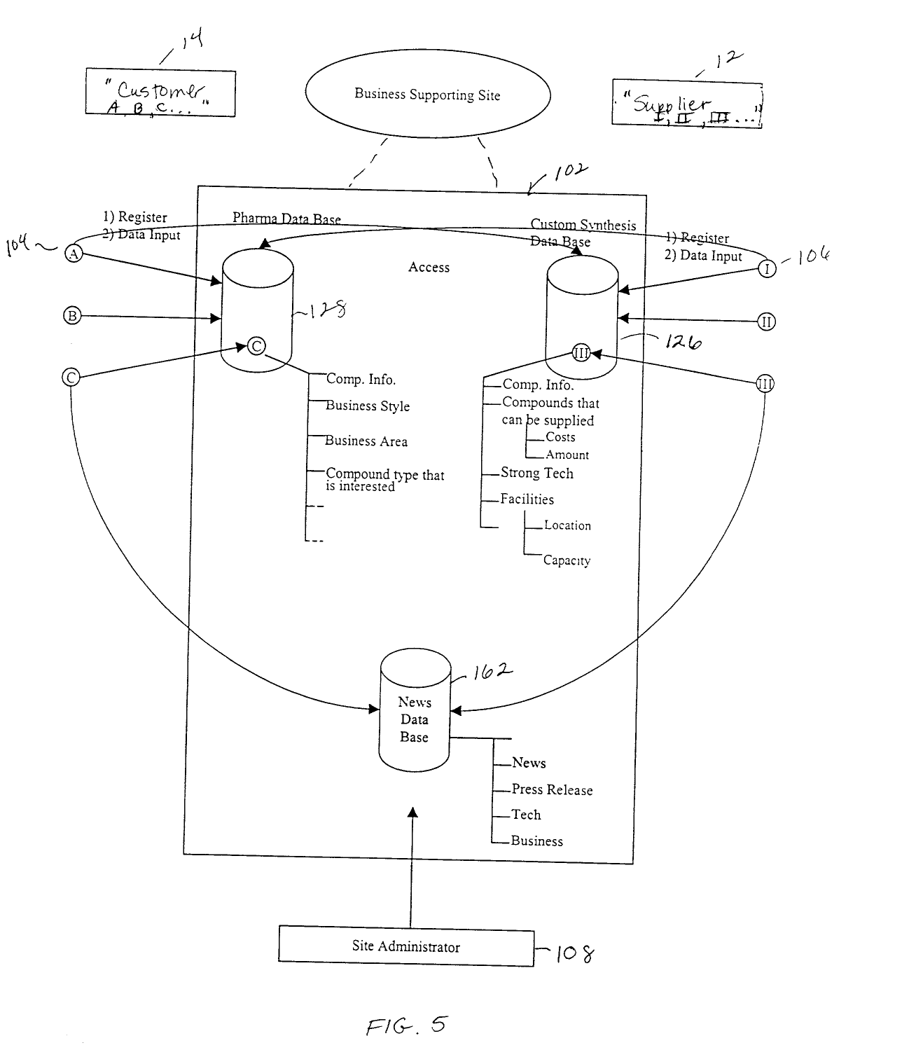

To facilitate interaction between customers and suppliers the business site 102 includes a registration module 125 and searchable supplier and customer registration databases 126 and 128, with associated software programs, as shown in greater detail in FIGS. 4 and 5. In order for customers and suppliers to access the functions or services provided by the system 100, they first register with business site 102 to become an authorized member of the system 100. The registration module 125 includes software to perform the registration function. HTML documents (Web pages) containing registration information and instructions are sent via the web server 120 to suppliers and customers at their request. The documents are reviewed and filled out and submitted to the business site 102. The registration process may include the execution of an online business agreement with a site administrator and the customer or supplier which sets forth the conditions of use of the system 100, the rights and liabilities of the parties, and the like. Upon registration, an automatically generated unique supplier or customer ID code, as the case may be, is assigned. In one embodiment, the unique ID code will include one or more data bits common to all suppliers, and one or more prefix data codes common to all customers in order to sort all suppliers and customers. For example, the unique ID code for all suppliers may have a prefix beginning with the letter “S” followed by a unique numeric sequence.

In one embodiment, a registration fee may be paid to the site administrator. The registration fee may be a one-time fee paid upon registration. Alternatively, registration may be renewed annually, and the registration fee is paid annually to the site administrator. Other types of registration fee payment schemes will be apparent to those of skill in the art and such alternative embodiments are within the scope of the present invention.

Upon registration, one or more registration databases are created for each supplier and customer, and record within the databases are associated with the unique ID code assigned at registration. In general, the registration database contains information pertaining to the supplier's capabilities and the customer's requirements, as shown more particularly in FIG. 5. Information pertaining to suppliers is stored in supplier registration database 126. Information pertaining to customers is stored in customer registration database 128. To create a record or file in the supplier registration database 126, the supplier 12 registers with the business site and inputs data into the system 100. Data input may be conducted via web pages; alternatively the data may be submitted directly to the site administrator who then enters the data into the registration database. In supplier registration database 126, information is recorded in a file for a particular supplier (such as “supplier file III” for supplier III) and may include (but is not limited to) any one, all, or any combination of the following data: (1) the supplier's general company information, location, contact persons, telephone and fax numbers and the like; (2) specific information regarding the supplier's facilities such as their type, location, capabilities and capacity; (3) a listing of chemical compounds that can be synthesized, their cost and volume; (4) the supplier's technology strengths, such as for example a supplier may have a particular expertise in performing hydrolysis reactions or posses specialized equipment and/or processes or chemical reactions; (5) safety information; (6) the supplier's FDA audit information; and (7) the supplier's terms and conditions of sale. Preferably, each information data entry is recorded in a separate data field within the file, and is independently searchable. It will be apparent to those of skill in the art that these are illustrative examples only and that many other types of information regarding a supplier's capabilities may be input and stored.

The customer 14 also registers with the business site 102 and inputs data pertaining to its company. The customer 14 may also input data pertaining to its requirements or needs, however this is not a requirement. For example, the customer may wish to keep its requirements or needs confidential. In this case, the customer may search for suitable suppliers, and then only after the customer has selected a supplier may the customer provide detailed information about its requirements. Whatever the content of the customer information, it is recorded in customer registration database 128 in individual files for each customer (such as “customer file A” for customer A), and may include (but is not limited to) any one, all, or any combination of the following data: (1) the customer's general company information, location, contact persons, telephone and fax numbers and the like; (2) the customers philosophy or business style; (3) the particular business area ft is in; (4) the chemical compound(s) it would like to obtain, the purity, volume and date of delivery; and (5) its purchase order terms. Preferably, each information data entry is recorded in a separate data field within the file, and is separately searchable. It will be apparent to those of skill in the art that these are illustrative examples only and that many other types of information regarding a customer's requirements may be input and stored.

III. Access and Communication

Due to the potentially confidential and/or strategic nature of the business transactions conducted between the supplier and customer, the present invention provides for different levels of access and communication. As mentioned above, customer A may not want to publically advertise that ft is seeking the synthesis of a particular chemical compound. Of particular advantage, the business site 102 includes hardware and software configured to employ varying levels of display and access. Customer A file in customer registration database 128 may have different levels of security associated with the different data fields in the file. For example, when customer A enters information into the customer registration database 128, customer A may select certain data fields as confidential or secure. FIG. 4 illustrates one example of data fields with different security access levels assigned to each entry in accordance with one embodiment of the present invention. For example, a compound list is provided which lists various chemical structures in separate data fields. In an exemplary embodiment, three levels of security or access are assigned to each compound or data field. The levels of security may be established by the site administrator, where level 1 is the least secure, level 2 is more secure and level 3 is the most secure, and so on as appropriate. In an illustrative embodiment, level 1 allows access by all registered members, i.e. suppliers and customers, of the system 100. Level 2 may allow access to the information only by suppliers, so that competitor of the customer (i.e. other customers) do not see the data. Level 3 may allow access only to one or more selected supplier who have first been authorized for access by the customer. Of course, these particular standards for the three levels are for illustration purposes only, and other standards and/or levels of security and access may be selected.

In FIG. 4 for example, a customer identified as #C00138946 has designated access to a particular chemical structure (chemical A) as security access level 3. Another customer, identified as #CO1290578, has set access to the same chemical structure as only security access level 1. Thus, when level 1 allows access to the information by all registered members of the system 100, a supplier could search the customer registration database and learn that customer #C01290578 has a requirement for the synthesis of chemical A. Alternatively, customer A may withhold its identify while allowing its compound of interest to be freely displayed or searchable at the first instance. In yet another example, supplier II may wish to allow access to only certain of its information (such as a facility) to only be viewed by limited customers. In this case supplier II may input data with a security level 3, and also input the identity of selected customers who may access the information. In another example, suppliers may allow access to their information only to customers in certain geographical locations. Those of skill in the art will recognize that many different types of criteria which determine the level of access to information may be established and implemented in software within the teaching of the present invention.

Of significant advantage, the present invention facilitates communication between customers and suppliers. Typically, the customer initiates the search for a suitable supplier; however this is not a requirement. As mentioned above a supplier may seek out business opportunities by searching for customers. Referring again to FIG. 2, the business information server 122 includes business transaction database 130 which includes software and/or hardware configured to provide records 131 relevant to interaction between a customer and supplier. Business transaction database 130 includes record locators representative of the parties. For example, where customer A and supplier I begin to conduct business, the business transaction database 130 creates a record or file 131 and establishes the filename “A-I”. Recorded in the business transaction database record 131 is information pertinent to the business relationship and dealings of the customer and supplier, and includes for example the chronological history of events between the parties, the negotiations between the parties, and the like. Business information server 122 includes software and/or hardware configured to limit access to records 131 via proper identification and/or password. The parties may communicate via email facilitated by mail server 124. Preferably, mail server 124 includes software and/or hardware configured to provide password protected, and optionally encrypted, confidential email communication between the parties. The parties may save the email communications in the relevant business record 131.

IV. Search Function

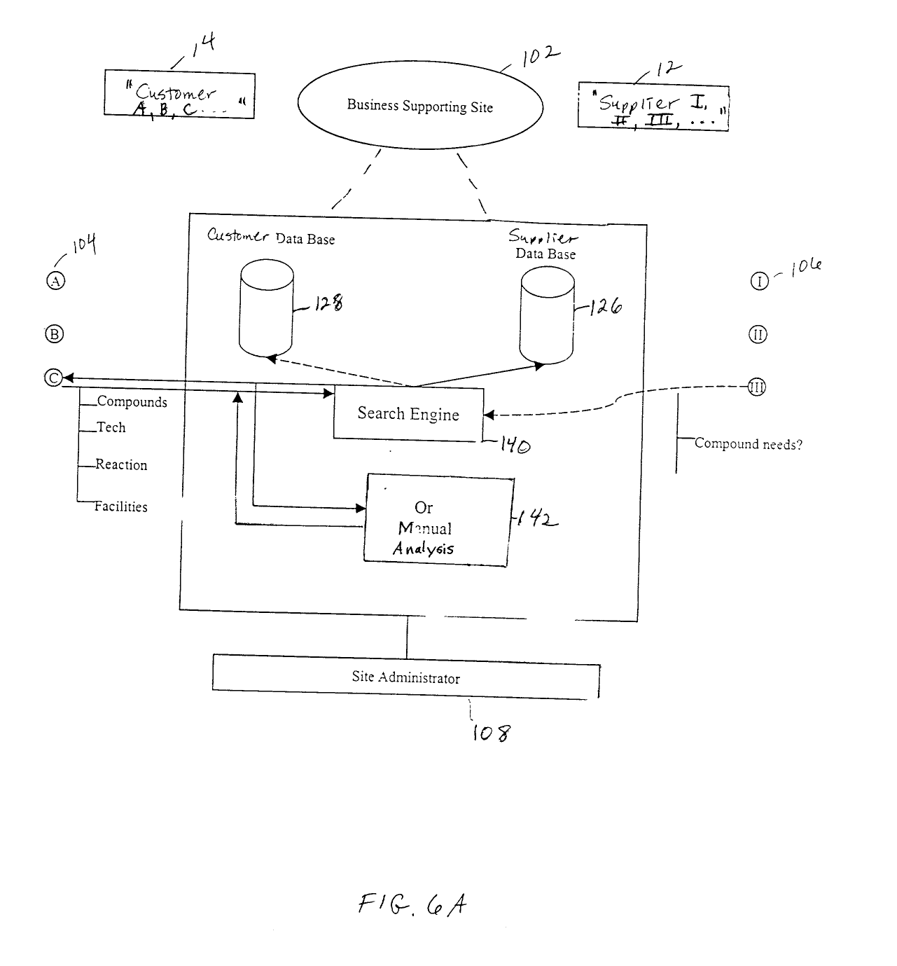

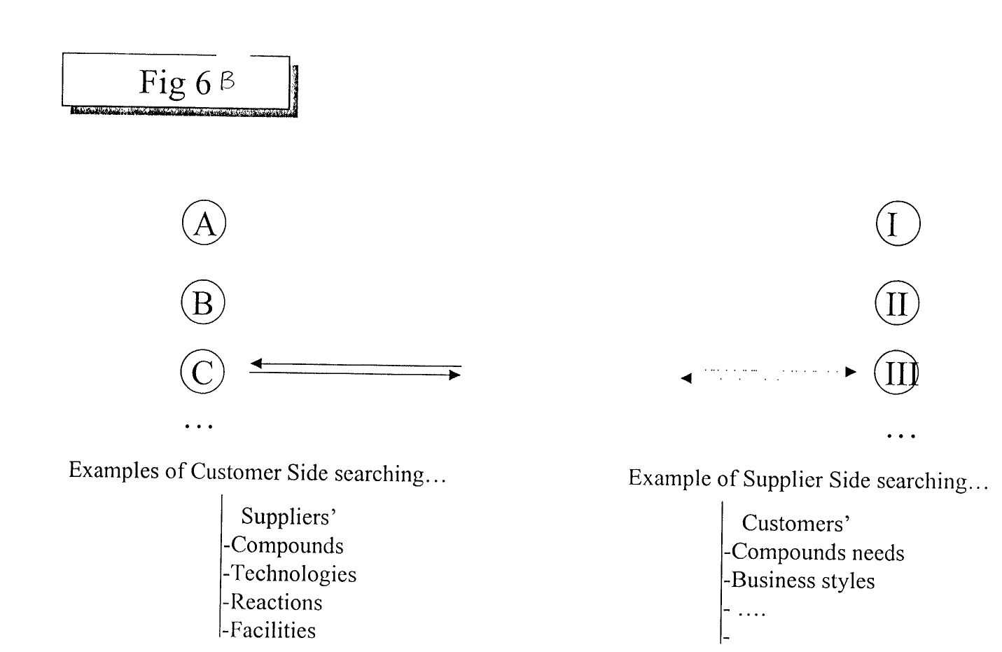

One of the advantageous features of the present invention is the search function. In particular, the system and method of the present invention is configured to provide detailed searching of the registration databases to facilitate transactions and/or partnering of potential customers and suppliers suited to the needs and capabilities of each party. Referring to FIGS. 6a and 6b, a high-level block diagram of the search computer architecture and flow of information is shown according to one embodiment of the present invention. Provided by the system 100 is a database management system (DBMS) or search engine 140 comprised of software and/or hardware configured to search the customer and supplier registration databases 126 and 128. Typically, searching is initiated by the customer, however a supplier may also conduct searching. The search engine 140 is connected to the customer and supplier databases. The search engine 140 contains software configured to provide key word searching capability, and various logic structure searching, such as boolean logic and the like. Examples of suitable search engines or database management systems which may be employed with the present invention, include but are not limited to that available from InfoBee at http:www-ntt-it.co.jp/goods/1ji/int/infobee/index.html and Namazu at http:www.namazu.org/index.html.en. Examples of search engines that are particularly suited for chemical compound name text based searching are Sci Finder, and ISIS. In the preferred embodiment, the searching function of the present invention further includes image matching software configured to provide image based searching, for example full or partial chemical structures may be input for searching. Examples of suitable software systems that provide image based searching which may be employed with the present invention include but are not limited to that available from ChemFinder, a commercially available chemical intelligent database manager and search engine, at http:www.cambridgesoft.com/products/family.cfm?FID=4.

In the typical case, a member logs on to the business site 102 and initiates a search by clicking on a search link provided on the business site 102. An entry box window will be displayed where the member enters one or more keywords. The keywords may include logic terms. For example if a customer is searching for a supplier capable of supplying a particular chemical compound, its intermediate or partial structure, and also wants to see if that customer has a certain type of specialized equipment or process capability associated with manufacture of the chemical compound or its intermediate, the customer might input the terms: “hydrogen AND high pressure reactor.” Further examples of search terms include: buthyllithium AND low temperature reactor; bulk (i.e. the drug itself AND clean room; thermal unstable chemicals AND thin film evaporator. A customer might input key words directed to the price of a compound, and/or its purity, quantity and the like. A customer might be interested only in custom synthesis services, and may input key words directed to a specialized processing technique or facility such as that required for the manufacture of hazardous or toxic materials such as antibiotics, steroids and the like. In an alternative embodiment, the customer may input a full or partial chemical structure, i.e. an image, as a search term. The site 102 preferably includes drawing software to allow members to draw chemical structures for searching. This may be implemented by commercially available drawing software, such as that available form ChemDraw, http://products.cambridgesoft.com, and ACD Structure Drawing Applet (ACD/SDA), http://www.acdlabs.com/products/iava/sda/. It is important to note that the search terms may be comprised of a wide variety of subject matter.

In the pharmaceutical and/or chemical industry the exact custom synthesized chemical compounds desired typically do not yet exist, and the chemical terms input for searching are most usually not the exact chemical compound required. In one embodiment, a similar compound, or a partial structure, both of which are processed using certain reactions to produced the desired synthesized chemical, may be entered for searching. In another instance, a customer may possess an intermediate compound, and searches for a supplier with specific technology, equipment, and/or one or more reaction appropriate for synthesis of the intermediate to form the desired compound. In further embodiments, customers may search suppliers that: 1) have technology and/or facility for synthesizing or treating special chemicals, for example antibiotics, steroids, carcinostatic agents, and the like; 2) can provide special reaction conditions, such as low temperature processes, high pressure process, fluorine compound process, and the like; 3) have facilities and/or management compliant with cGMP regulations; or 4) have optical resolution technology capabilities.

In a preferred embodiment, the searching feature of the present invention is configured to display the search results in descending order of matching. The search function may be configured to provide an output where the consistency ratio is calculated for each search result, and the search results are displayed in descending order with the result having the highest numerical value of the consistency ratio listed first. The consistency ratio is well known in the art and is commonly used to sort and display search results. The consistency ratio feature may be used for text based searching of chemical compounds. Software that provides this feature is available from ISIS, among other commercial software packages.

Additionally, the present invention may provide the function of manual searching. More specifically, a manual search module 142 is provided wherein the site administrator can provide the service of performing the search, and/or providing analysis to order the search results. For example, the site administrator having knowledge in chemical synthesis, may view the chemical search results, and then based on its knowledge of synthesis the site administrator can suggest that one or more of the chemical compounds found in the search may be processed with a particular reaction route to lead to the desired chemical. Optionally, a consulting fee may be payable to the site administrator for this service.

The following example is provided to illustrate one embodiment of the system and method of the present invention, and is not intended to limit the scope of the invention in any way; the general flow chart of this search function is also shown in FIG. 6b:

Customer A accesses the business site 102 and initiates a search for suppliers that have the capability to produce Fialuridine. Customer A, believes that the key synthetic technologies or process steps to produce Fialuridine are 1) fluorination, and 2) protection and de-protection of sugar OH group; with one reaction route shown below:

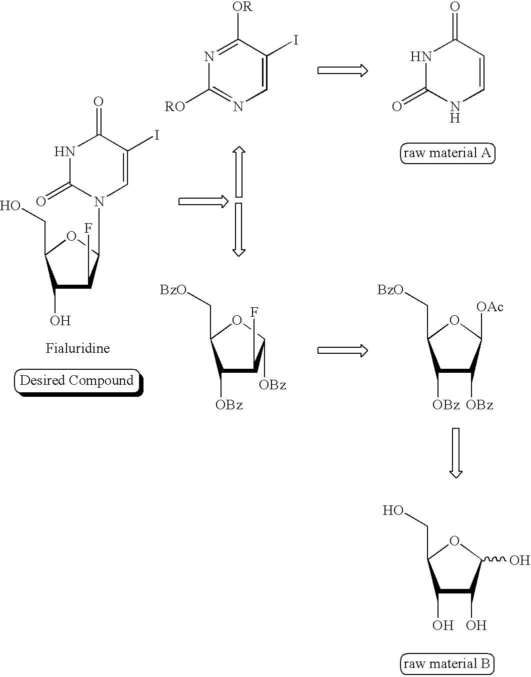

Customer A can determine, using reverse synthesis which is well known in the chemical field, the possible raw materials that are needed to synthesize Fialuridine. In this instance, Fialuridine is a specialized drug, and the customer may also search for suppliers that possess cGMP facilfties and management ability needed for producing the product. In one embodiment, the customer may carry out the method of the present invention in the following steps:

Step 1: The customer searches for the compound Fialuridine using an image based search. To use the image based search the customer inputs (or draws in) the chemical structure of Fialuridine where prompted by the business supporting site 102. In this example the search does not produce any hits.

Next in Step 2: The customer searches for one or more partial structures which may then be synthesized using appropriate process steps to produce the desired compound Fialuridine. The customer inputs one possible partial structure of Fialuridine, as shown below as “Partial Structure C” and executes a search. The results of the search are displayed, and there is a hit with the structure “Lodenosin” and its supplier name “Supplier III.” Supplier III is displayed because it is registered as a supplier of Lodenosin in the supplier database.

Input Structure

[symbol]

Search Results

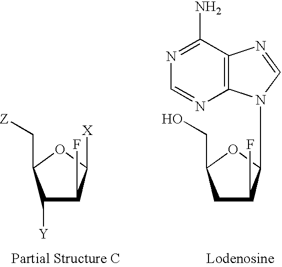

Supplier Name: “Supplier III”

In Step 3: The customer further searches the capability of supplier III by accessing the supplier database for all or some of the available information. The database information reveals that supplier III has fluorination technology, sugar OH group protection and de-protection technology, and has a cGMP facility and management ability. Thus, supplier III appears to be a good candidate for a business transaction with the customer.

Step 4: While supplier III appears be a good candidate for synthesizing the partial chemical structures above to produce the desired compound, supplier III does not appear to possess the raw materials needed. Thus, the customer searches for the raw materials in this step. In this example, the customer searches for one of the raw materials, Uracil, using a key word search, and finds suppliers IV and V as candidates. The customer then searches for the second raw material, D-ribose, using a key word search and finds suppliers VI, VII and VIII as candidates.

Thus, according to the system and method of the present invention the customer has quickly and conveniently identified a custom synthesis company (supplier III) that is capable of producing the product Fialuridine. Supplier III does not have the raw materials needed for producing Fialuridine, however these raw materials are found to be available from other suppliers.

V. Auction Function

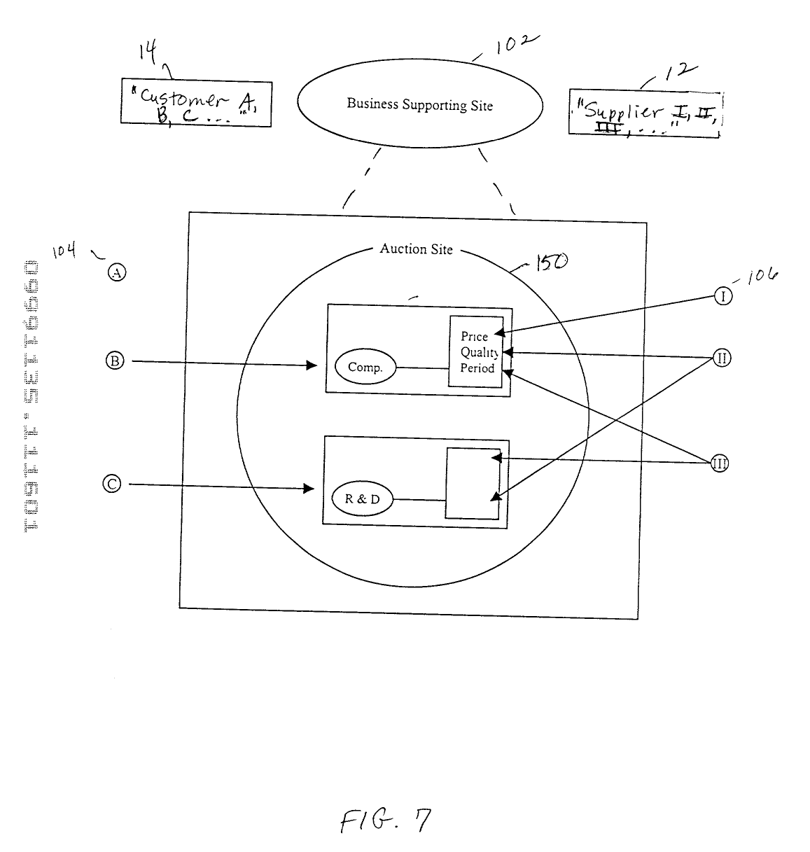

In another aspect, the system and method of the present invention is configured to provide an auction to facilitate transactions and partnering of potential customers and suppliers suited to the needs and capabilities of each party. Referring to FIG. 7, a high-level block diagram of the auction computer architecture and flow of information is shown according to one embodiment of the present invention. Provided by the system 100 is an auction site 150 comprised of software and/or hardware configured to conduct an auction. In the most usual case, a customer will display a desired chemical compound, either by name or chemical structure, and request that bids be received. Suppliers place bids, and the content of the bids will include the price to supply the chemical, and may also include many other terms such as the quality or purity of the chemical, period for delivery, and the like.

In an alternative embodiment, a reverse auction may be conducted. In this instance, a supplier can display on the auction site an offer to supply a certain chemical compound at a certain price, quality, and/or delivery, time and the like. One or more customers can then accept the offer if it meets their requirements.

In both embodiments, two different auction styles may be provided, a “public auction” and a “private auction.” The public auction as defined herein is an auction which is open to all members of the business site 102. That is all members may view and/or participate in the auction. The private auction, as defined herein, may take a number of forms and generally refers to an auction which is conducted with some level of limited access and is not open to all members of the business site 102.

The private auction may be implemented in a variety of ways, with different levels of access. In one exemplary embodiment of a private auction, customer A may initiate the auction by posting or requesting bids for a particular chemical compound, and wherein the auction is open only to suppliers. In this embodiment, other customers, which may be competitors of customer A will not see the chemical compound customer A wishes to have synthesized. In another exemplary embodiment of a private auction with more limited access, the auction may be open only to a selected group of suppliers. In one example, the private auction is implemented with software and hardware configured to assign an unique number or code to those suppliers who have been authorized by the customer to participate in the private auction. The supplier must input its code which is then verified by the auction site software in order to gain access to the auction. Alternatively, the private auction may be carried out as a silent auction where the customer does not disclose its identity, and only discloses its identity upon acceptance of a bid to the one selected supplier.

In a further embodiment of the private auction function of the present invention, the auction site 150 includes software and hardware configured to allow suppliers to limit access to their bids. For example, a supplier may allow only the customer to see the contents of its bid. Alternatively, the supplier may allow the other suppliers participating in the auction to view its bidding information. In one example, this function may be implemented by software and/or hardware of the action site 150 which assigns a unique code or number to the customer which permits the customer to have access view the bids of suppliers.

Thus, a variety of auction styles are possible, and include, but are not limited to: an open bid where the identity and contents of the bid are open to all parties; a closed or private bid where the customer allows the contents of the bid to be open only to suppliers, or alternatively to a selected group of suppliers; and where the customer does not specify the type of action, the supplier can choose whether the contents of their bid is open to other suppliers.

VI. Advertisement Function

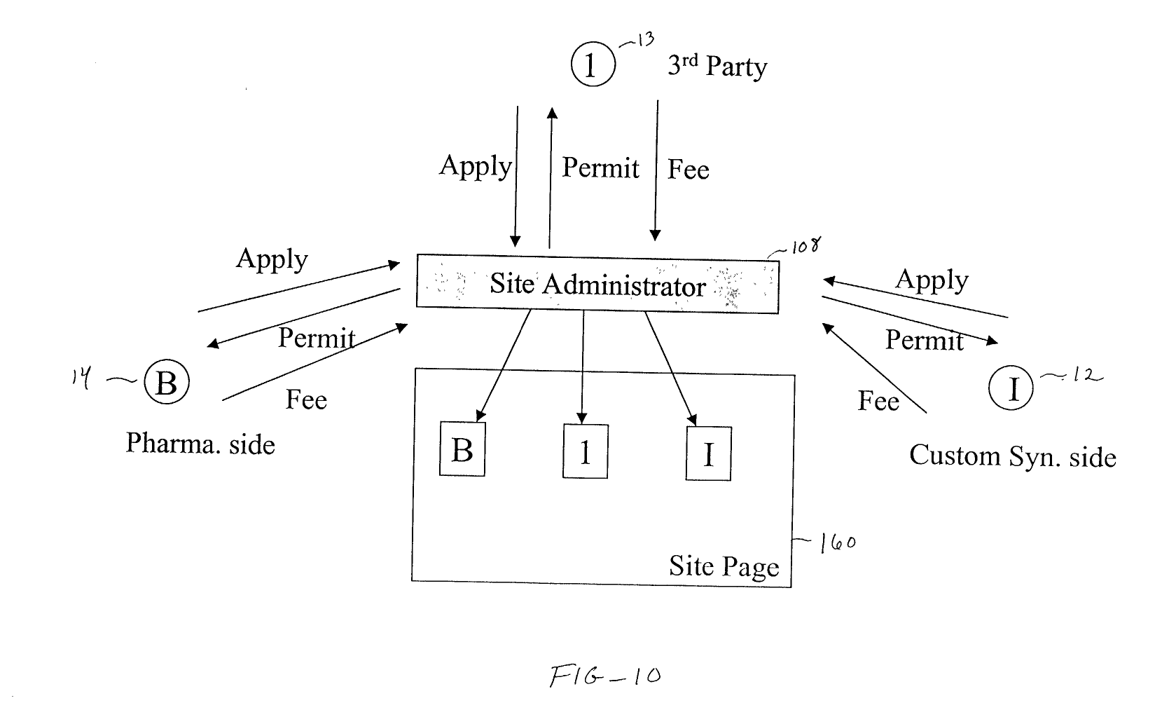

Advertisements may be provided on the business support site 102. Preferably the advertisements are of a nature that are of interest to the suppliers and customers. The site administrator 108, for payment of a fee, license royalty, or other remuneration, contracts with one or more parties to provide advertisements or banner ads on advertisement modules 160 (shown in FIGS. 4 and 10). The advertising party may be a customer or a supplier, or alternatively may be a third party advertiser. Examples of third party advertisers include, but are not limited to, suppliers of commodity type chemicals, equipment and/or metrology manufacturers, design software suppliers, and the like.

Typically, advertisers will pay an advertising fee to the site administrator 108 for utilization of the advertisement space, as described further below. In general, the advertising fee may be based on any one of, combination of, or all of the following aspects: the identity of the party placing the advertisement (i.e. whether customer, supplier or third party), the area of the ad space, the position of the page, the type of webpage (i.e. at the home page, or a further deep page), and the size of the file (for example, large files which contain large images or video will typically generate a larger fee).

VII. News Function and Links to Other Resources

In a preferred embodiment the business site 102 includes news database 162 (shown in FIG. 5) having software configured to display one or more news features and to provide links to one or more third party resources that are of interest to the customer and supplier members. For example the site administrator may post periodic news articles on the site 102 such as technology or business trends in the pharmaceutical or chemical industry, significant mergers in the industry, regulatory developments, and the like. Additionally, press releases regarding both member customers and suppliers may be posted. Meetings, conferences and events of interest to the member customers and suppliers may also be provided.

Business site 102 further preferably includes links to other resources of interest to the customers and suppliers. The site administrator 108, for payment of a fee, license royalty, or other remuneration, contracts with one or more parties to provide access to their databases. Referring back to FIG. 2, one or more third party databases 166 may be connected to the business site 102 via appropriate web servers. Confirmation module 168 is provided at business site 102 and includes software and/or hardware configured to confirm that the third party database is authorized for connection to the business site 102. Any type of suitable third party database may by employed. Examples include but are not limited to links to databases containing: FDA announcements, FDA drug information such as a drug approval list and the Drug Master File (DMF) information, safety information, route development information, additional compound search information, and the like. It is important to note that many types of information and links may be provided in addition to the examples described herein, and that such information and links may be periodically changed and/or updated.

VII. Fee Procedures

The site administrator may obtain fees for use of the system 100 in a variety of ways. Those skilled in the art will recognize from the foregoing description that other types of fee payment methods may be employed without departing from the scope of the present invention. In general, any one, all, or any combination of the following fee procedures are employed according to the present invention: registration fee, site utilization fee, business fee, payment transaction fee, and auction fee.

As described above, suppliers and customers register with the business supporting site 102. The business supporting system includes registration software which accesses the registration fee to the customers and suppliers, and upon their registration with the business supporting system a fee is paid to the site administrator 108. The registration fee may be a one-time fee paid upon registration. Alternatively, registration may be renewed annually, and upon renewal, a registration fee is paid to the site administrator. Other types of registration fee payment schemes will be apparent to those of skill in the art and such alternative embodiments are within the scope of the present invention.

In another embodiment of the present invention, a site utilization fee may be paid to the site administrator. The business site includes software configured to structure the site utilization fee in any number of ways. In one embodiment, a site utilization fee may charged based on the period of time the member is actively using the functions or features on the business site 102. In another embodiment, the site utilization fee may be charged based on events. Events may be defined in a variety of ways, but most typically will be associated with the use of one of the functions of the business site 102. For example, conducting a search may be defined as an event for which a site utilization fee is charged. In another example, accessing an outside or third party database may be defined as an event.

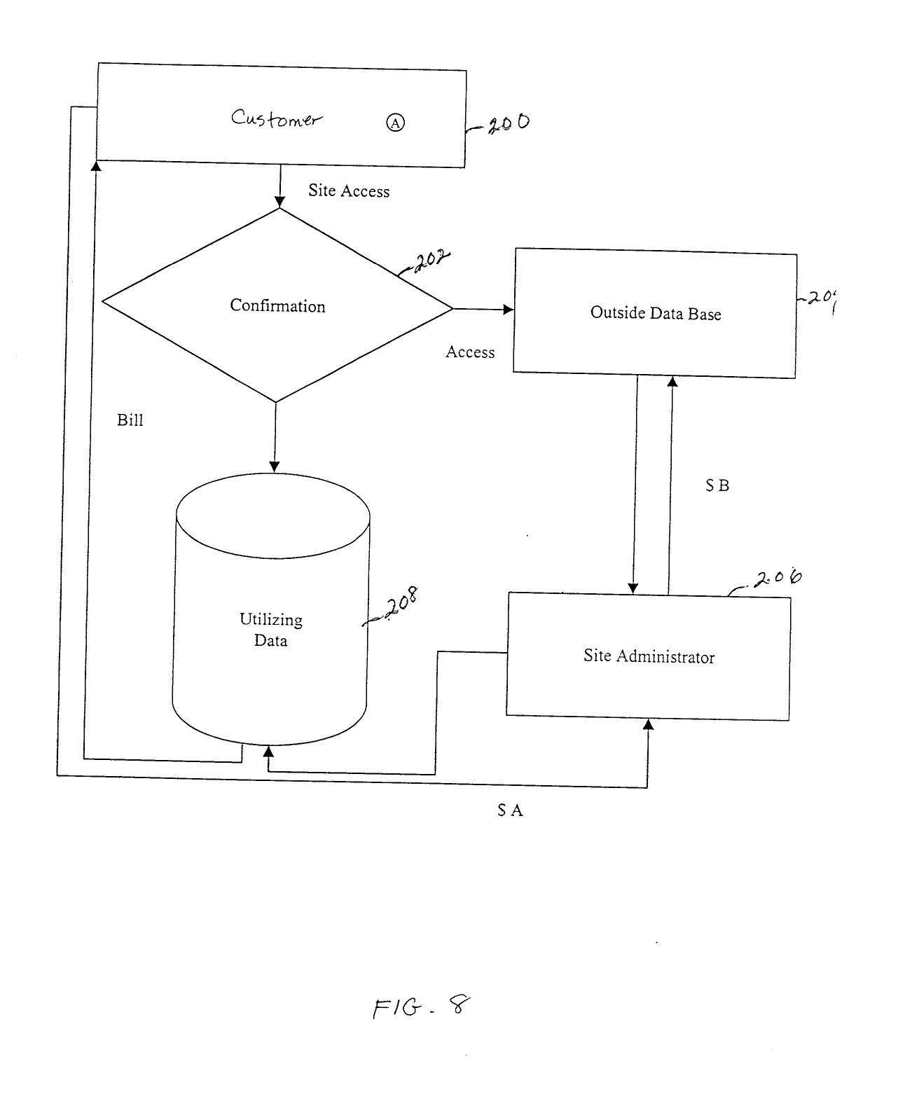

A flow chart illustrating one site unitization fee example of the present invention is shown in FIG. 8. A member, such as a customer, obtains access to the business site 102 and requests access to an outside database in step 200. Confirmation is preformed in step 202 to confirm that the outside database is an authorized and if so, access is obtained to the outside database 204. To track usage, access to the outside database and retrieval of information from the outside database is conducted via the site administrator in step 206. Typically, the site administrator will make a payment to the outside database for access and retrieval of the information. The information is sent to customer for its use in step 208. A charge for this service is sent directly to customer A from the site administrator.

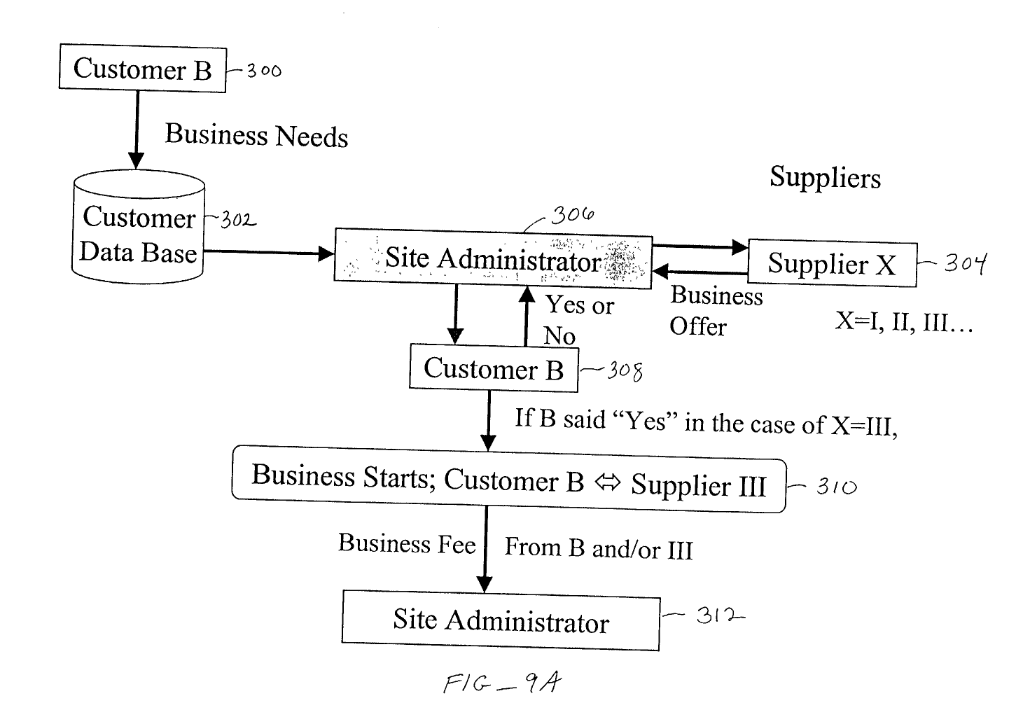

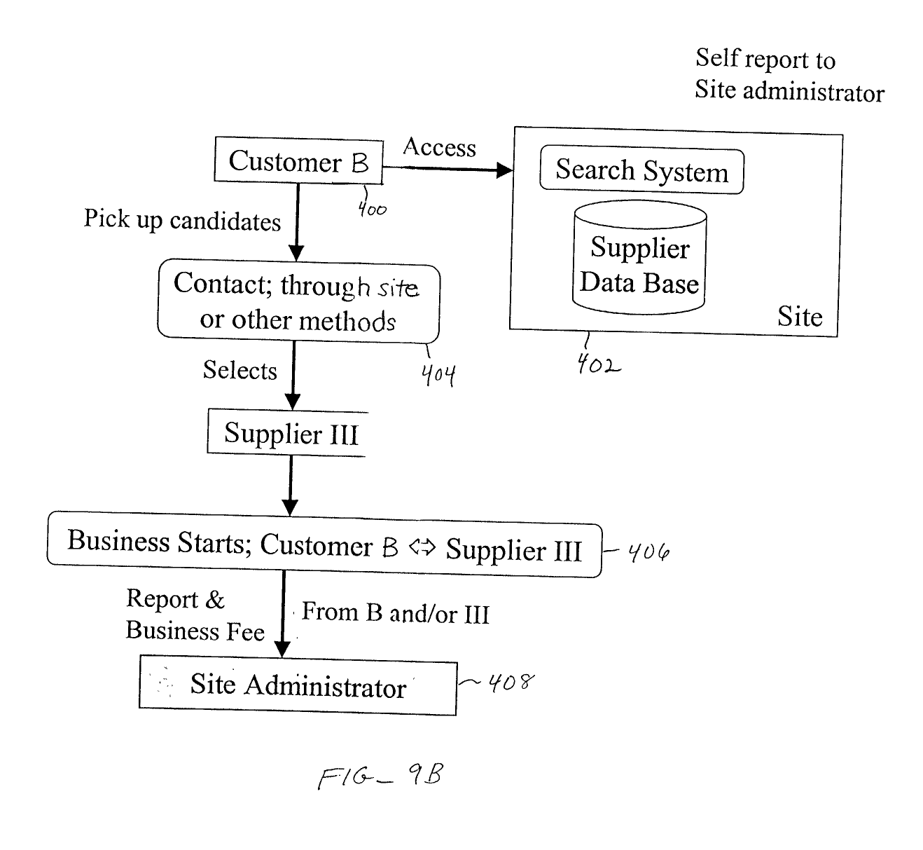

In another embodiment of the present invention, a business fee may be paid to the site administrator. The business fee may take a variety of forms, but in general the business fee is charged for the service offered by the system 100 that facilitates business transactions between customers and suppliers. In one example, the business site includes software configured such that a business fee is charged when a customer and supplier enter into a business transaction facilitated by the business site 102. FIG. 9A is a flow chart illustrating one example of the business fee method of the present invention. Customer B 300 searches the supplier registration database in step 302 and identifies Supplier III as a potential partner. Supplier III makes a business offer in step 304 to the site administrator at 306. The site administrator communicates this business offer to Customer B at step 308. If Customer B rejects the offer, the rejection is communicated to Supplier III, who may then make a counter offer through the site administrator to Customer B, steps 306 and 308. If Customer B accepts the offer, the business transaction is entered into at step 310, and a business fee is calculated at step 312.

In general, the business fee is based on a fixed fee, or alternatively is a percentage of the value of the business transaction. FIG. 9B illustrates an alternative embodiment of the business fee method of the present invention. In this example, Customer B 400 identifies Supplier III through the business site 102 at step 402; however Customer B and Supplier III continue their communication directly in step 404 and not through the business site 102. In the event the parties enter into a business transaction in step 406, this is reported to the site administrator at 408.

In another embodiment of the present invention, an auction fee is paid to the site administrator when an auction is conducted. The auction fee may take a variety of forms as implemented by software configured on the business site. In one embodiment, an auction entry fee is charged to the member who initiates the auction. The auction fee may be a fixed fee or a percentage of the price of the goods or services sold at the auction. In another embodiment, a bid fee may also be charged to a member who places a bid in response to a request made at the auction. The bid fee may be a fixed fee, or a percentage of the price of the goods or services sold at the auction. Preferably, the bid fee is charged to all members who place a bid at the auction. In a further embodiment, the auction may be offered free of charge when a party initiates the bidding. Then, if a business transaction is established, the party initiating the biding and/or the biding party may pay a fee based on the value of the business transaction.

Various promotions may be provided by the site administrator. For example, newly registered members may receive free usage of the business site 102 and all of its features for a certain period of time such as 30 or 60 days. Alternatively, a discount may be offered for a certain period of time as opposed to free usage. Other promotions that may be offered by the site administrator include limited time discount offers on any one of the fees for the services listed above, and the like.

In another embodiment of the invention, an advertisement fee is paid to the site administrator for advertising on the business site 102. FIG. 10 illustrates one example of the method of paying the advertising fee according to the present invention. The site administrator 108, for payment of a fee, license royalty, or other remuneration, may contract with any one of, combination of, or all of the customers 14, suppliers 12, or third parties 13 to provide advertisements or banner ads on advertisement modules 160. In general, the advertising fee may be based on any one of, combination of, or all of the following aspects: the identity of the party placing the advertisement (i.e. whether customer, supplier or third party), the area of the ad space, the position of the page, the type of webpage (i.e. at the home page, or a further deep page), and the size of the file (for example, large files which contain large images or video will typically generate a larger fee).

VIII. Experimental

To facilitate a more complete understanding of the scope of the present invention, the following examples of different variations of certain of the functions are provided below. These examples are provided for illustrative purposes only, and are not intended to limit the scope of the present invention in any way.

Examples of information provided by the customer to be input to the searchable customer registration database, includes: Company name, Section name, Address and contact information, net sales and size of the company's R&D budget. Additionally, information regarding safety data for desired compounds may be provided, such as mutagen information, physiological activity, and the like. This information is important for a supplier to know in order for the supplier to determine what type of facility and/or specialized equipment may be needed to produce the compound for the customer.

Examples of information provided by the supplier to be input to the searchable supplier registration database, includes: company name, address, sales amount in the drug business area, contact information, business connections (such as representative clients, and financial contacts such as banks, and the like); production sites; skillful technology such as reactions, unit operations (including reaction conditions), unit process, and the like; facilities including location, capacity, reactor data (size, material, temperature, pressure), clean room facilities (class rating); product list including chemicals name, availability (amount, price); current Good Manufacturing Practice (cGMP) compliance and capability; ISO certification; Drug Master File (DMF) No. and the number of submitted DMF; working experience with manufacture the bulk compound itself or advanced intermediates; working experience with dangerous and/or toxic drugs such as Carvinostatics, Steroids, Antibiotics and whether the supplier has separate facilities exclusively for production of such drugs; the supplier's audit experience including who conducted the audit (for example the FDA) the date of the audit, the results of the audit and how many times the supplier has been audited, the supplier water treatment capabilities; environmental capabilities, solvent recovery, waste water treatment; information regarding the personnel of the supplier, for example the number of employees who are in charge of production of the desired compounds, the number of researches involved in production development, and the number of researchers that have advanced education such as PhD degrees, and the like.

Examples of links to resources provided on the business site include: patent data bases such as IBM Patent Server, STO's Internet Patent Search System, WPI (World Patent Index), USPTO data base (US Patent &Trademark Office), CNIDR, and JPO-IPDL (Japan Patent Office—Industrial Property Digital Library); drug developing information data bases including: Pioneer, PharmaProject, Daily Essential, World Drug Index, and World Drug Alerts; price of drugs database such as Drug Launches; FDA announcements, FDAweb page; www.fda.gov; meeting, conference, and exhibition information; Daily Essential listings; drug safety information; chemicals safety data bases such as MSDS (Material Safety Data Sheet) and hazardous information about chemicals such as that available form www.hazard.com/msds; drug lists such as the DMF (Drug Master File); http://www.fda.gov/cder/dmf and http://www.chemicalinfo.com/products/fdabase/overview.html; additional Chemicals search systems or web sites such as DWCP (Directory of World Chemical Producers); www.chemicalinfo.com, ISIS; other chemical web sites such as ChemX; www.chemx.com, Worldwide Contract manufactures Directory; www.chemicalinfo.com; design software may be made available such as organic synthesis reactions, or route search systems such as Sci Finder, ISIS, Cross Fire, Synthline, Reacs, APHOS (Artificial Intelligence for Planning and Handling Organic Synthesis); computational chemistry software may be made available such as MOPAC, MM, DFT (Density Functional Theory); and drug business area information such as Daily Essential; www.prous.com/home_daily/index.html.

As seen from the foregoing example, the present invention provides a significant advantage of offering vast and powerful information to its members at one location. Some of the above listed third party resources require separate access or purchase, and thus a member would have to subscribe separately to many resources. The present invention provides the convenience and efficiency of providing all the resources in one site.

Examples of news sources provided on the site include: news in the business area; financial news; announcements and/or reports; FDA news, various countries' Ministry ofWelfare information, press releases of member companies, announcements of meetings, conferences, exhibition, and the like.

Examples of information provided by a member requesting an auction may include: the customers' name, compound name, chemical structure of the desired compound, desired quality desired quantity, desired delivery date, package style, desired production site (or area), for example Europe or North America only, requirements for cGMP's, compounds feature such as bulk, active pharmaceutical ingredient, advanced intermediate, intermediate, or raw material; the method of production; fixed or not fixed; and characteristics of the final targeted drug, such as it name, chemical structure, product number, development phase and its indication (efficacy or pharmaceutical action).

Moreover, a customer may request specialized processing, such as desired special treatment needed for highly toxic and/or poisonous compounds such as phosgene, Carcubistatics, Antibiotics, Steroids, and the like; notices for treatment needs; timing, period, amount; specialized facilities such as whether separate facilities are used to manufacture toxic and poisonous compounds exclusively so that contamination does not occur; and characteristics of the final targeted drug, such as its name, chemical structure, product number (brand name, generic drug name, Laboratirt code), development phase, and its indication (efficacy or pharmaceutical action).

In another example, a member may wish to out source its R&D, and may request: Details of R&D outsourcing terms and capabilities; target, Desired cost, Desired Term, Final targeted drug's;—name,—chemical structure, the Product number, Development Phase, and Indication (Action)

Examples of advertisements that may be displayed include those from: the member customers and/or suppliers, consulting companies, reagent producers, constructing companies, equipment producers, custom safety analysis (test) companies, custom analysis companies, publishing companies, trading companies, temporary worker assigning agency, DMF (Drug Master File) preparation service, language translation service companies, exhibition companies, design of exhibits companies, printing companies, travel agencies, exhibit managers, and booth contractors.

As described system and method of the present invention provides a powerful system and method to facilitate business interaction between customers and suppliers in the custom synthesis industry. In summary, any one, all, or any combination of the following functions are performed by the present invention: the registration database is provided containing detailed information regarding suppliers and/or customers; to find suitable partners and transactions, the databases may be searched for a number of criteria as described above; secure communication between customers and suppliers may be established and conducted; an auction may be conducted; suppliers, customers and others may advertise on the system; members may view the latest news and information relevant to the pharmaceutical, chemical and custom synthesis industry; and members may access other relevant resources via links on the site. Thus, the present invention provides significant functionality over the basic, limited function of buying and selling commodity chemicals as provided by the prior art systems.

The foregoing description of specific embodiments and examples of the invention have been presented for the purpose of illustration and description, and although the invention has been illustrated by certain of the preceding examples, it is not to be construed as being limited thereby. They are not intended to be exhaustive or to limit the invention to the precise forms disclosed, and obviously many modifications, embodiments, and variations are possible in light of the above teaching. It is intended that the scope of the invention encompass the generic area as herein disclosed, and by the claims appended hereto and their equivalents.

1. An electronic commerce system for enabling business transactions between one or more customers and suppliers, comprising
a customer system which provides information representative of the needs of one or more customers for the procurement of custom synthesis products and/or services;
a supplier system which provides information representative of the capabilities of one or more suppliers to supply the custom synthesis products and/or services; and
a business supporting system which facilitates business transactions between said one or more customers and suppliers.

2. The electronic system of claim 1 wherein said business supporting system includes a customer registration database having one or more records which contain information representative of said one or more customers needs.

3. The electronic system of claim 1 wherein said business supporting system includes a supplier registration database having one or more records which contain information representative of said one or more suppliers capabilities.

4. The electronic system of claim 2 or 3 wherein the records in each of said customer and supplier registration databases include a plurality of fields, and each field has associated with it a selectable access or security level which determines a level of access and display of the information in the field.

5. The electronic system of claim 1 wherein said business supporting system further comprises an email server which implements electronic communication between any two of said customers and supplies, said email server including software and/or hardware configured to permit secure communications between said customers and suppliers.

6. The electronic system of claim 1 wherein said business supporting system further comprises a new database which stores and displays information relevant to interests of said customers and supplies.

7. The electronic system of claims 2 or 3 wherein said business supporting system further comprises one or more database management systems having software and/or hardware configured to search said customer and supplier registration databases responsive to a request from the customer or supplier for said information.

8. The system of claim 1 wherein said business supporting system further comprises an auction system having software and/or hardware configured to implement an auction wherein one or more of said suppliers or customers offer bids to supply or procure custom synthesis products and/or services.

9. The system of claim 8 wherein said auction system includes software and/or hardware which implements either an open auction where any of said customers and suppliers participate in the auction, or a private auction where only authorized customers and suppliers participate in the auction.

10. The electronic system of claim 1 where said business supporting system further includes one or more advertisements displayed thereon upon payment of an advertising fee to an administrator of said business supporting system.

11. The electronic system of claim 1 where said business supporting system includes registration software configured to implement a registration fee payable by any of said one or more customers and suppliers upon registration with the business supporting system.

12. The electronic system of claim 1 where said business supporting system includes software configured to implement a site utilization fee payable by any of said one or more customers and suppliers for use of the business supporting system.

13. The electronic system of claim 1 where said business supporting system includes software configured to implement a business fee payable by any of said one or more customers and suppliers for commencement of a business transaction between a customer and supplier, said business fee being a fixed fee or a percentage of a value of the business transaction.

14. The electronic system of claim 1 wherein said business supporting site includes software configured to implement an auction fee payable by any of said customers and suppliers for conducting an audit on said business supporting system.

15. The electronic system of claim 2 wherein said information provided in said customer database is comprised of any one, all or any combination of the following customer information:
company information, location, contact persons, telephone numbers, fax numbers, field of business, chemical compounds needed for syntheses and its purity, volume and desired delivery date, and purchase terms.

16. The electronic system of claim 3 wherein said information provided in said supplier database is comprised of any on, all or any combination of the following supplier information: company information, location, contact persons, telephone number, fax numbers, facilities and their type, location, capabilities and capacity, chemical compounds that can be synthesized and their cost, purity and volume, technology strengths, specialized equipment, specialized processes, safety history, FDA audit history, and terms of sale.

17. A computer readable medium containing instructions which, when executed by a computer, provide an electronic commerce system which enables business transactions between one or more customers and suppliers, by:
receiving information representative of needs of one or more customers for the procurement of custom synthesis products and/or services;
receiving information representative of capabilities of one or more suppliers to supply the custom synthesis products and/or services; and
facilitating business transactions between said one or more customers and suppliers.

18. A method of enabling business transactions between one or more customers and suppliers, comprising the steps of:
receiving information representative of needs of one or more customers for the procurement of custom synthesis products and/or services;
receiving information representative of capabilities of one or more suppliers to supply the custom synthesis products and/or services; and
facilitating business transactions between said one or more customers and suppliers.

19. The method of claim 18 further comprising:
establishing a customer registration database having one or more records which contain information representative of said one or more customers needs.

20. The method of claim 18 further comprising:
establishing a supplier registration database having one or more records which contain information representative of said one or more suppliers capabilities.

21. The method of claims 19 or 20 further comprising:
selecting an access or security level to be associated with fields established in each of the records in each of said customer and supplier registration databases which determines a level of access and display of the information in the field.

22. The method of claim 18 further comprising:
any of said customers and suppliers electronically communicating with each other using an email server, said email server including software and/or hardware configured to permit secure communications between said customers and suppliers.

23. The method of claims 19 or 20 further comprising:
searching any one of said customer and supplier registration databases responsive to a request from the customer or supplier for information.

24. The method of claim 18 further comprising:
conducting an auction where one or more of said suppliers or customers offer bids to supply or procure custom synthesis products and/or services.
